(19) United States
(12) Patent Application Publication
(10) Pub. No.: US 2014/0351330 A1
(43) Pub. Date: Nov. 27, 2014

(54) SERVICE PROFILE MAINTENANCE

(71) Applicant: Microsoft Corporation, Redmond, WA (US)

(72) Inventors: Jacob Andrew Sabulsky, Kirkland, WA (US); Zainab Hakim, Sammamish, WA (US); Harris Syed, Redmond, WA (US); Simon Leet, Redmond, WA (US); Sarjana Sheth, Redmond, WA (US); Sermet Iskin, Issaquah, WA (US)

(73) Assignee: Microsoft Corporation, Redmond, WA (US)

(21) Appl. No.: 13/901,709

(22) Filed: May 24, 2013

(51) Int. Cl. H04L 29/08

(52) U.S. Cl. CPC H04L 67/00
USPC 709/204

(57) ABSTRACT

One or more techniques and/or systems are provided for dynamically maintaining a service profile. That is, a user may be associated with a variety of services, such as an email service, a social network service, a photo sharing service, etc. An operating system may dynamically provide support for services by maintaining service profiles. For example, a service provider application may specify a service definition defining a service not yet supported (e.g., a social network app may describe functionality and/or information about a new social network service). A service profile may be generated for the service based upon the service definition. The service profile may be exposed to system components and/or applications that may utilize the service profile to access information and/or functionality provided by service (e.g., a camera system component may allow a user to upload a photo to the new social network service utilizing the service profile).

### BACKGROUND

Many users utilize applications to consume functionality provided by services. In an example, a user may install a social network application on a mobile device in order to access social network functionality provided by a social network service (e.g., the user may view user profiles, share content, send messages, etc.). In another example, a user may utilize a web browser to access a personal email account hosted by a personal email service. In another example, a user may install a microblogging application on a tablet device in order to share and/or view textual posts shared through a microblogging service. A user may have many user accounts (e.g., a social network login, an email login, a microblogging login, etc.) and/or contact lists (e.g., a social network friend list, an email address book, a microblogging follower list, etc.) for such services, which may be cumbersome for the user to manage.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for dynamically maintaining a service profile are provided herein. That is, an operating system of a device (e.g., a laptop, a tablet, a mobile phone, a computer, a video game system, a television cable box, etc.) may host one or more applications that are associated with services. For example, a social network application may be associated with a social network service, a microblogging application may be associated with a microblogging service, a video chat application may be associated with a communication service, etc. It may be advantageous to aggregate user accounts from such services for utilization by the operating system (e.g., an operating system user interface such as a welcome screen or desktop interface), system components (e.g., a camera of a device), or other applications (e.g., a photo editing application). In this way, a user may have a robust experience where information from various services may be provided to the user through a single interface, which may be less cumbersome than individually opening applications, separately logging into accounts, and separately interacting with services through the applications. For example, the operating system may be capable of providing social network data through a first operating system user interface tile, video chat capabilities through a second operating system user interface tile, and/or a wide variety of other content and capabilities associated with services. Services may be added, updated, and/or removed from the system (e.g., from the operating system) based upon information provided by applications. In this way, a user can add a service (e.g., a service not hardcoded into the operating system) for utilization by the operating system, system components, and/or other applications by merely installing an application that can define information related to the service.

In an example, an application may be identified as a service provider application. A service provider application may be an application that is capable and/or trustworthy of defining a service. For example, a user may install an instant messaging application that declares itself as a service provider application having knowledge about one or more services (e.g., the instant messaging application may be associated with an application manifest specifying a service provider parameter identifying the instant messaging application as a service provider application). A service definition may be received from the service provider application (e.g., through an operating system application programming interface (API), through a service definition file stored within an operating system folder by the service provider application, etc.). The service definition may define the service associated with the service provider application (e.g., the instant messaging application may define an icon, a service ID such as a URL, a service display name, a set of capabilities such as messaging or photo sharing, and/or a variety of other information defining an instant messaging service).

A service profile for the service may be generated based upon the service definition. The service profile may be exposed to a system component, a second application, or other entity. In an example, the service profile may be exposed to an operating system desktop interface. Utilizing the service profile, the operating system desktop interface may access instant messaging service information from the instant messaging service. For example, the operating system desktop interface may display an instant messaging icon, an instant messaging service name, an ability to send a photo message, an instant messaging contact list, an instant messaging history, etc. In another example, the service profile may be exposed to a second application such as an email application. Utilizing the service profile, the email application may access instant messaging service information from the instant messaging service utilizing the service profile. For example, the email application may provide a user with the instant messaging contact list and the ability to send a photo message to a contact within the instant messaging contact list. Service profiles may be dynamically added, removed, and/or updated. In this way, the operating system may maintain an extensible service profile platform (e.g., as opposed to merely supporting a few services hardcoded into the operating system during release or from an operating system update).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of dynamically maintaining a service profile.

FIG. 2 is an illustration of an example of a user having user accounts with multiple services.

FIG. 3 is a component block diagram illustrating an exemplary system for dynamically managing a service profile.

FIG. 4 is an illustration of an example of a service profile database.

FIG. 5 is an illustration of an example of an operating system welcome screen displaying service information associated with one or more services.

FIG. 6 is an illustration of an example of a camera interface displaying service information associated with a photo sharing service.

FIG. 7 is an illustration of an example of a photo editor app displaying service information associated with a photo sharing service.

FIG. 8 is an illustration of an exemplary computer readable medium wherein processor-executable instructions configured to embody one or more of the provisions set forth herein may be comprised.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

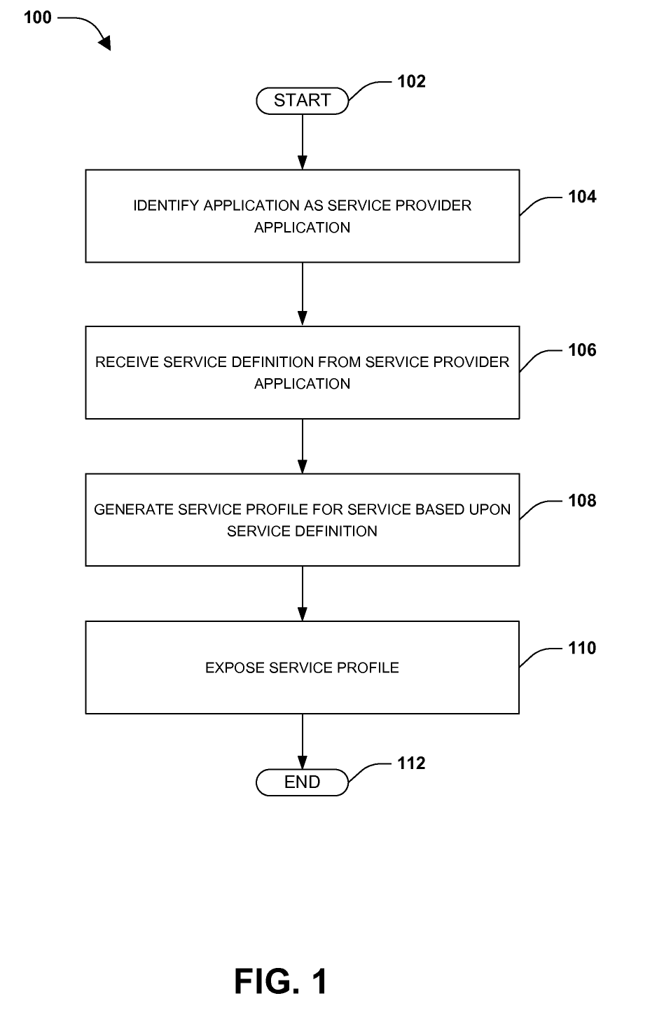

An embodiment of dynamically maintaining a service profile is illustrated by an exemplary method 100 of FIG. 1. At 102, the method starts. At 104, an application may be identified as a service provider application. In an example, a user may install a school social network application that allows the user to interact with other users of a school social network service. In an example of identifying the school social network application as a service provider application, installation information (e.g., a declaration that the school social network application may provide trustworthy information regarding the school social network service) associated with the school social network application may be validated during installation of the school social network application. For example, the school social network application may correspond to a marketplace app available through an app marketplace. Because the school social network application is available through the app marketplace, the app marketplace can preliminarily verify (e.g., through testing) that the school social network application provides trustworthy descriptions of services that the school social network application claims to support, such as when the school social network application is onboarded to the app marketplace. In another example of identifying the school social network application as a service provider application, an application manifest associated with the school social network application may be received. The application manifest may specify a service provider parameter identifying the school social network application as a service provider application. The service provider parameter may be validated (e.g., the application manifest may be authenticated). In this way, the school social network application may be validated as a service provider application capable of defining the social network service.

At 106, a service definition may be received from the service provider application. The service definition may define the service associated with the service provider application. For example, the school social network application may specify a school social network service ID such as a website address or IP address, an icon corresponding to a school mascot, display name for the school, capabilities of the school social network service such as messaging, profile viewing, posting, etc., and/or a variety of other information used to display information related to the school social network service, access service information from the school social network service, and/or facilitate execution of functionality provided by the school social network service, for example. In an example, the service definition may be received through an operating system application programming interface (API) exposed to the service provider application. In another example, the service provider application may store a service definition file within an operating system folder. In this way, the operating system may access a service definition comprised within the service definition folder. It may be appreciated that a variety of techniques may be used to provide and/or receive the service definition.

At 108, a service profile may be generated for the service based upon the service definition. In an example, a school social network service profile may comprise service display information specifying how the service is to be presented (e.g., by an operating system interface, a system component, a second application, etc.). The service display information may specify an icon used to visually represent the school social network service (e.g., an icon representing a mascot of a Technology Learning School), a display name (e.g., “Technology Learning School”), a service ID (e.g., a URL or IP address used to access the school social network service), etc. In another example, the school social network service profile may comprise a set of capabilities associated with the school social network service. For example, the school social network service may support a messaging capability, a social network profile access capability, a social network post capability, a calendar access capability, and/or other actions invokeable through the social network service (e.g., register for a class, email a professor, submit homework, etc.). It may be appreciated that a service profile may specify a wide variety of capabilities, such as a video call capability of a video chat service, an email capability of a personal email service, a phone call capability of an internet phone service, etc.

In an example, the service profile may be stored into a service profile database dynamically maintained by an operating system. In this way, a service may be dynamically introduced to the operating system based upon information provided by a service provider application. Thus, a user may influence what service information is provided and/or supported by the operating system by merely installing an application that is a service provider application (e.g., the operating system is not limited to supporting a few services that are initially hardcoded into the operating system and/or added through operating system updates). Accordingly, the ability of the operating system to support services may be extensible. In an example, services may be added, removed, and/or updated. For example, the service profile may be removed based upon a service profile removal request (e.g., the service profile removal request may be triggered based upon uninstallation of the service provider application, a request from the user, a notice that the service is no longer available, etc.). In another example, the service profile may be updated based upon a service profile update from the service provider application (e.g., a new icon may be specified for the service). In another example, the service provider application may specify service definitions for multiple services, and thus multiple service profiles may be generated based upon information provided by the service provider application (e.g., the school social network application may have knowledge about a school sports social network service).

At 110, the service profile may be exposed to a system component, a second application, and/or other entities. In an example, an operating system user interface (e.g., a desktop interface, a welcome screen interface, a tile interface, a menu options interface, a dropdown action list interface, etc.) may display an action capable of being performed by the school social network service (e.g., upon selecting a school social network contact displayed by the operating system user interface, a dropdown action list specifying a send message and/or other actions capable of being performed through school social network service may be displayed to a user). In another example, an operating system welcome screen interface may obtain service information from the school social network service utilizing the service profile. The operating system welcome screen interface may display the service information, such as a new homework assignment assigned to the user, through a tile interface. In another example, a second application, such as an image editing application, may be invoked to obtain service information from the school social network service by accessing the school social network service utilizing connection information within the service profile (e.g., the image editing application may utilize the connection information to retrieve an image attached to a message within a user inbox maintained by the school social network service). In this way, various system components and/or applications may utilize dynamically defined service profiles in order to access service information and/or facilitate actions associated with services. At 112, the method ends.

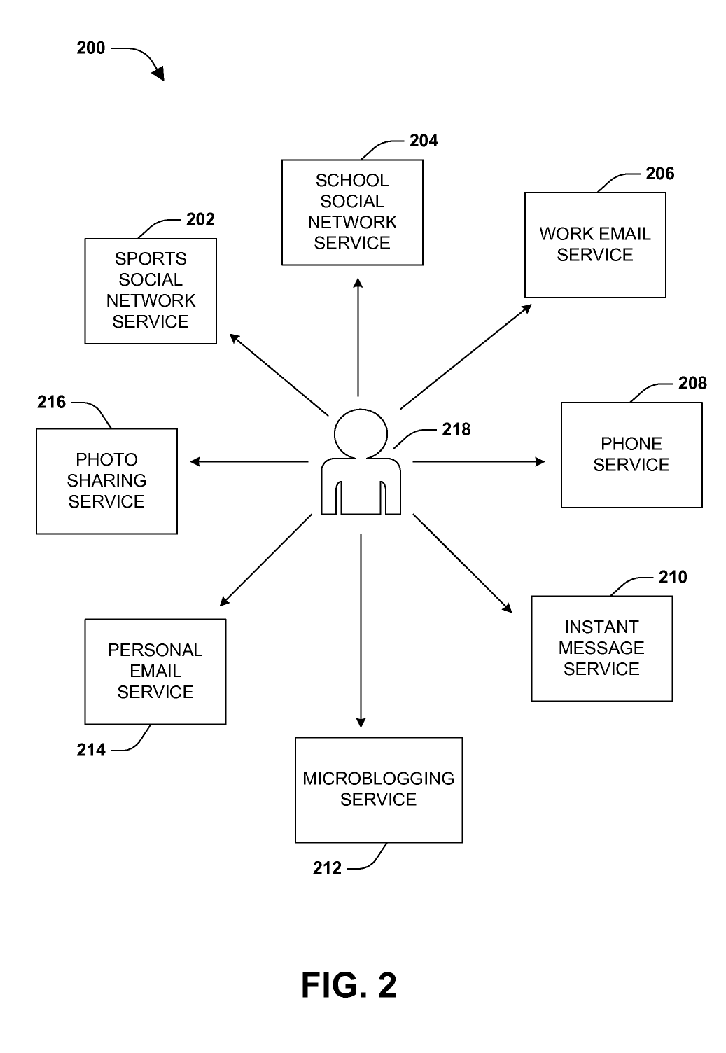

FIG. 2 illustrates an example 200 of a user 218 having user accounts with multiple services. The user 218 may have a first account with a sports social network service 202, and may access the sports social network service 202 through a sports social network website, a sports social network app, etc. The user 218 may have a second account with a school social network service 204, and may access the school social network service 204 through a school social network website, a school social network app, etc. The user 218 may have a third account with a work email service 206, and may access the work email service 206 through a work website, an email application, etc. In this way, the user 218 may have a wide variety of user accounts with various services, such as a phone service 208, an instant message service 210, a microblogging service 212, a personal email service 214, and/or a photo sharing service 216. It may be cumbersome for the user 218 to access the services using various websites, application, and/or account login information. For example, the user may browse to the sports social network website and login in order to access the first account. The user may separately browse to the school social network website and login in order to access the second account. The user may separately open a microblogging app to access the microblogging service. Thus, it may be advantageous to provide an aggregated service experience for the user, such as through a single operating system interface, for example.

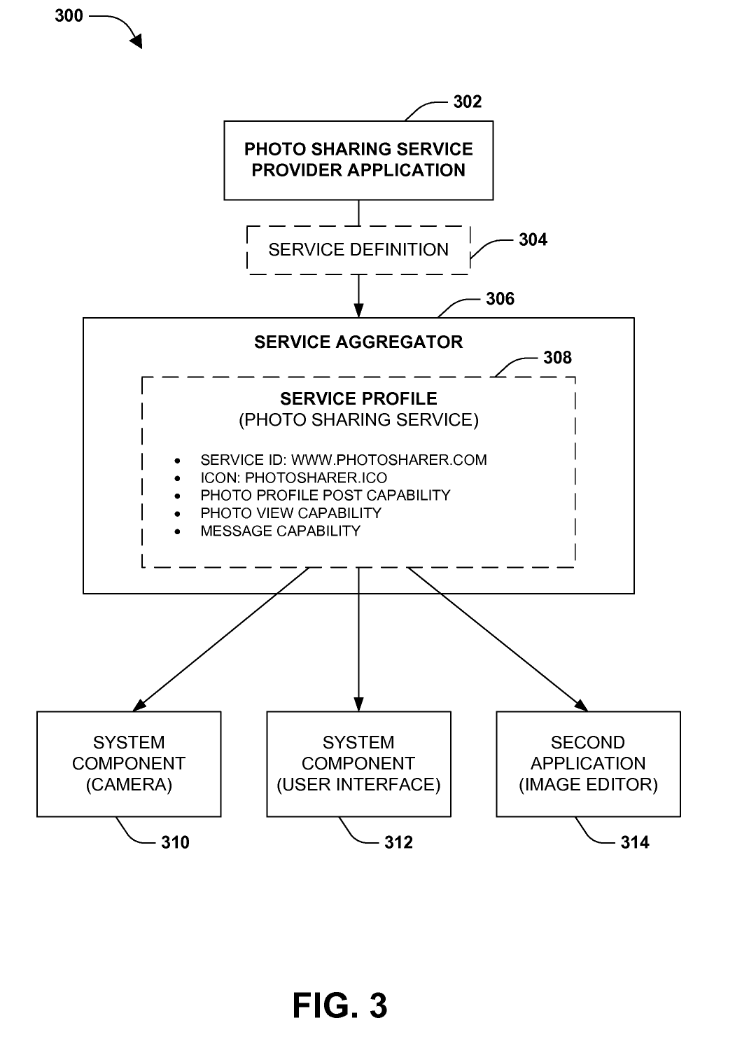

FIG. 3 illustrates an example of a system 300 for dynamically managing a service profile 308. The system 300 may comprise a service aggregator 306. In an example, an operating system owns (e.g., maintains) the service aggregator 306. The service aggregator 306 may be configured to identify an application as a service provider application (e.g., an application manifest for a photo sharing application may specify a service provider parameter as True). For example, the service aggregator 306 may identify the photo sharing application as a service provider application (e.g., photo sharing service provider application 302). The photo sharing service provider application 302 may be associated with a photo sharing service that allows users to upload, share, message, and/or download photos through the photo application and/or a photo sharing website, for example.

The service aggregator 306 may be configured to receive a service definition 304 from the photo sharing service provider application 302 (e.g., through an operating system API, through a service definition file, etc.). The service aggregator 306 may be configured to generate the service profile 308 associated with the photo sharing service based upon the service definition 304. In an example, the service profile 308 may specify a service ID (e.g., www.photosharer.com, an IP address, etc.) used to access the photo sharing service. The service profile 308 may comprise an icon (e.g., a photosharer.ico file corresponding to a logo of the photo sharing service) that may be displayed by the operating system, a system component, and/or other applications to represent the photo sharing service. The service profile 308 may comprise a set of capabilities supported by the photo sharing service, such as a photo profile post capability, a photo view capability, a message capability, and/or other actions supported by the photo sharing service. It may be appreciated that merely a few examples of information specified within a service profile are illustrated for simplicity.

The service aggregator 306 may be configured to expose the service profile 308 to one or more system components and/or one or more applications. In an example, the service aggregator 306 may expose the service profile 308 to a camera system component 310. In this way, the camera system component 310 may allow a user to perform an action supported by the photo sharing service, such as posting a photo captured by the camera system component 310 to a user photo board hosted by the photo sharing service. In another example, the service aggregator 306 may expose the service profile 308 to a user interface system component 312, such as an operating system welcome interface. In this way, the operating system welcome interface may utilize the service profile 308 in order to access and display service information obtained from the photo sharing service (e.g., logo from .ico file, a photo stream of photos shared by friends of the user, etc.). In another example, the service aggregator 306 may expose the service profile 308 to a second application, such as an image editor app 314. In this way, the image editor app 314 may provide the user with the ability to access and/or edit images shared through the photo sharing service.

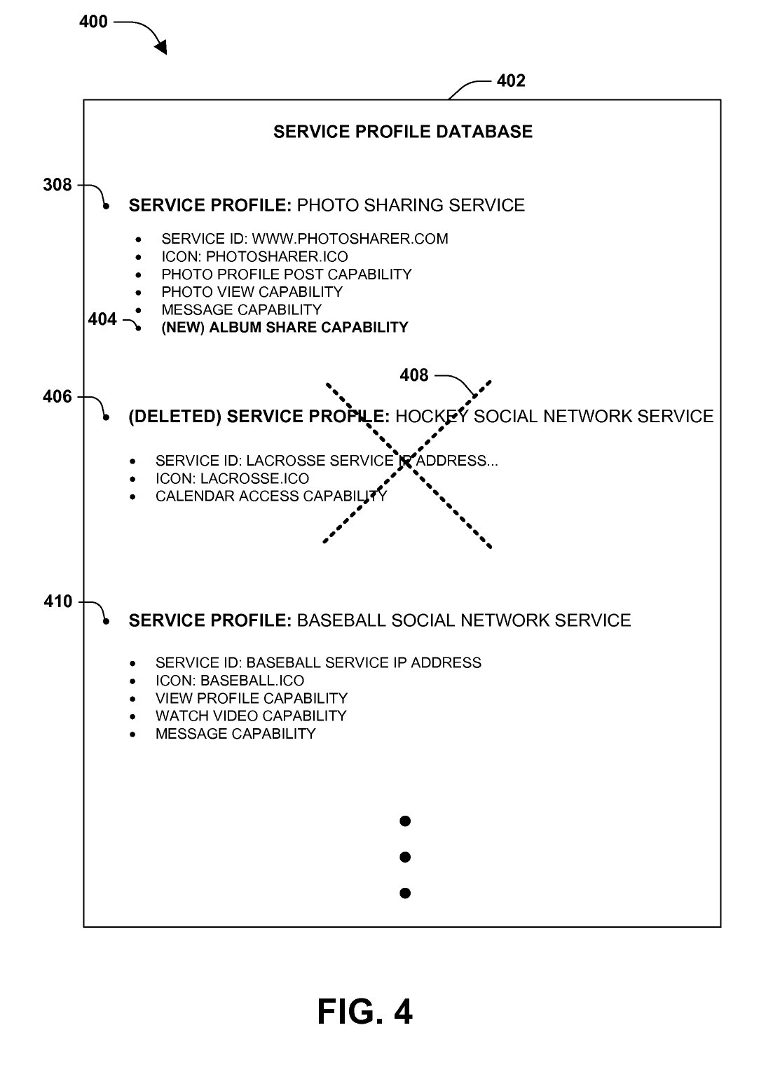

FIG. 4 illustrates an example 400 of a service profile database 402. In an example, the service profile database 402 is maintained by an operating system. The service profile database 402 may comprise one or more service profiles, such as a service profile 308 associated with a photo sharing service (e.g., service profile 308 generated by the service aggregator 306 of FIG. 3), a service profile 406 associated with a hockey social network service (e.g., generated based upon a hockey service definition provided by a sports service provider application), a service profile 410 associated with a baseball social network service (e.g., generated based upon a baseball service definition provided by the sports service provider application), and/or other service profiles not illustrated.

The service profile database 402 may be dynamically maintained such that service profiles may be updated, removed, and/or added. In one example, a service profile update may be received from a photo sharing service provider application 302 illustrated in FIG. 3. The service profile update may specify a new service profile parameter 404 defining an album share capability for the photo sharing service (e.g., an upgrade to the photo sharing service may have added support for sharing photo albums). Accordingly, the new service profile parameter 404 may be added into the service profile 308 for the photo sharing service. In another example, a service profile removal request may be received, such as from the sports service provider application. The service profile removal request may indicate that the hockey social network service is no longer available (e.g., the hockey social network service may have shut down). Accordingly, the service profile 406 for the hockey social network service may be removed 408 from the service profile database 402.

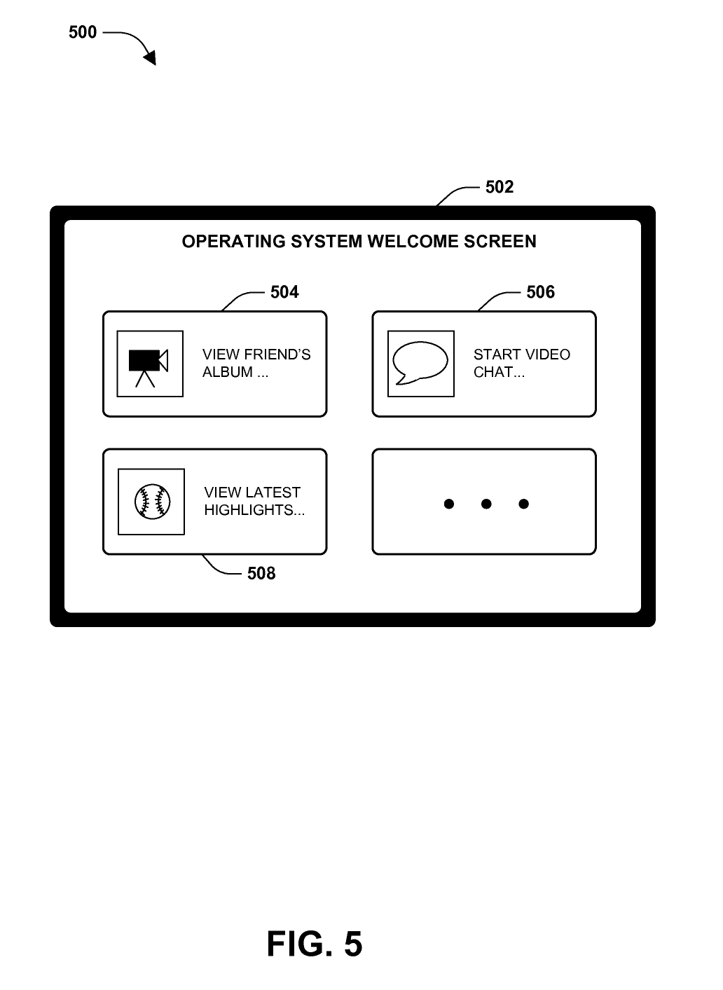

FIG. 5 illustrates an example 500 of an operating system welcome screen 502 displaying service information associated with one or more services. That is, a device, such as a touch device, may comprise an operating system. The operating system may maintain a service profile database (e.g., service profile database 402 of FIG. 4). The operating system welcome screen 502 of the operating system may comprise one or more information interfaces (e.g., tiles) associated with services defined by service profiles within the service profile database. In an example, a photo sharing interface 504 may allow a user to view a friend's album shared through a photo sharing service. In another example, a school social network interface 506 may allow the user to start a video chat session with a friend through a school social network service. In another example, a baseball interface 508 may allow the user to view recent game highlights published by a baseball social network service. In this way, user account information (e.g., service information retrieved from services) may be aggregated and/or displayed to a user in an organized manner (e.g., through a single interface, such as the operating system welcome screen 502).

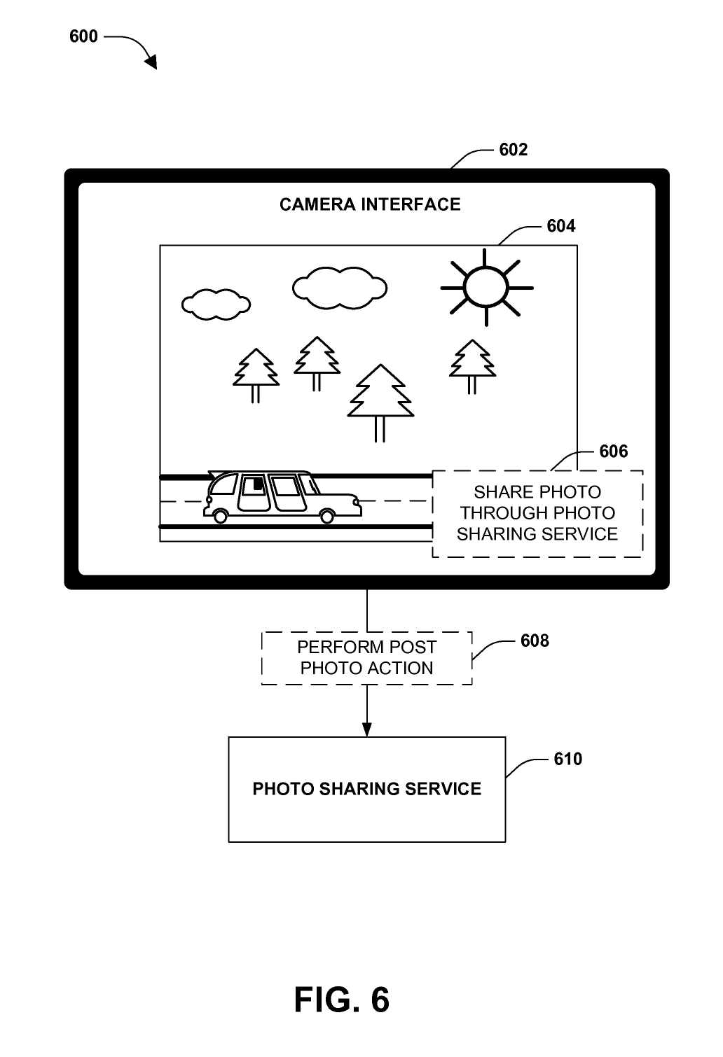

FIG. 6 illustrates an example 600 of a camera interface 602 displaying service information associated with a photo sharing service 610. That is, a device, such as a tablet device, may comprise a camera system component configured to provide camera functionality (e.g., photo capture, view captured photos, etc.) through the camera interface 602. A service profile (e.g., service profile 308 of FIG. 3) may be exposed to the camera interface 602. The service profile may describe the photo sharing service 610, such as capabilities of the photo sharing service 610 (e.g., an ability to perform a post photo action 608 to a user photo board). In an example, a user may capture a photo 604 using the camera system component. Based upon the service profile, the camera system component may display a share photo action 606 for the photo 604. Responsive to selection of the share photo action 606, the camera system component may invoke, utilizing the service profile, the photo sharing service 610 to perform the post photo action 608. In this way, the camera component may interact with the photo sharing service 610 utilizing the service profile.

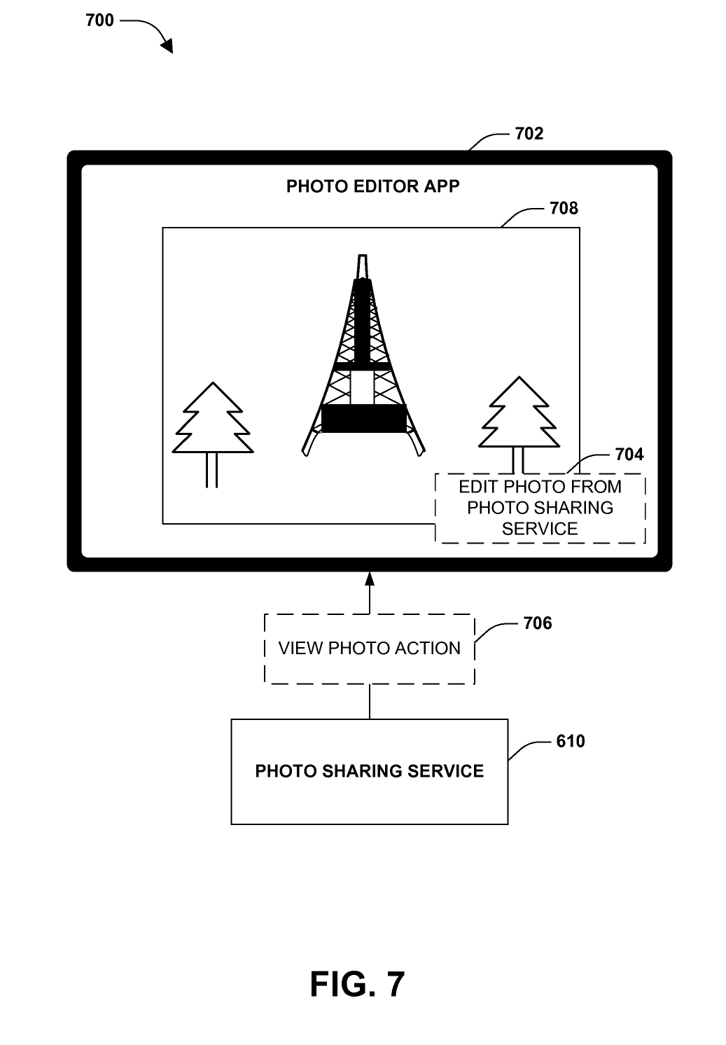

FIG. 7 illustrates an example 700 of a photo editor app 702 displaying service information associated with a photo sharing service 610. That is, a device, such as a laptop, may host the photo editor app 702 configured to provide photo editing functionality. A service profile (e.g., service profile 308 of FIG. 3) may be exposed to the photo editor app 702. The service profile may describe the photo sharing service 610, such as capabilities of the photo sharing service 610 (e.g., an ability to view photos shared through the photo sharing service 610). In an example, the photo editor app 702 may utilize the service profile to access a photo 708 shared through the photo sharing service 610 (e.g., view photo action 706). The photo editor app 702 may allow a user to edit 704 the photo 708 obtained from the photo sharing service 610. The photo editor app 702 can utilize the service profile to post the edited photo back to the photo sharing service 610.

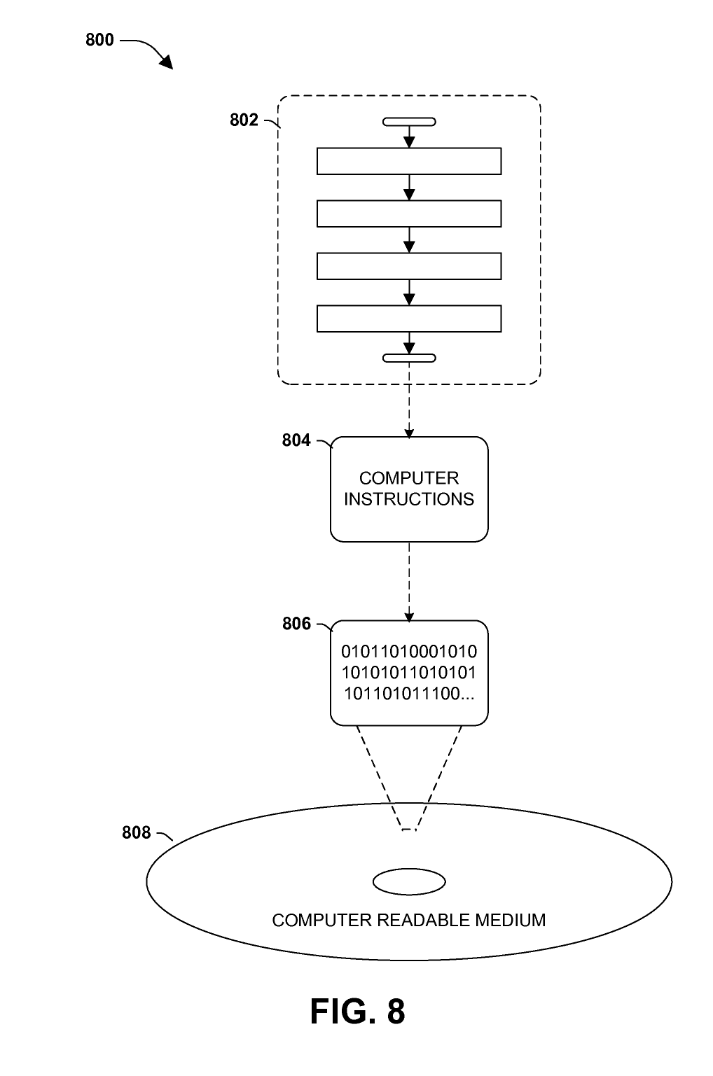

Still another embodiment involves a computer-readable medium comprising processor-executable instructions configured to implement one or more of the techniques presented herein. An example embodiment of a computer-readable medium or a computer-readable device that is devised in these ways is illustrated in FIG. 8, wherein the implementation 800 comprises a computer-readable medium 808, such as a CD-R, DVD-R, flash drive, a platter of a hard disk drive, etc., on which is encoded computer-readable data 806. This computer-readable data 806, such as binary data comprising at least one of a zero or a one, in turn comprises a set of computer instructions 804 configured to operate according to one or more of the principles set forth herein. In some embodiments, the processor-executable computer instructions 804 are configured to perform a method 802, such as at least some of the exemplary method 100 of FIG. 1, for example. In some embodiments, the processor-executable instructions 804 are configured to implement a system, such as at least some of the exemplary system 300 of FIG. 3, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

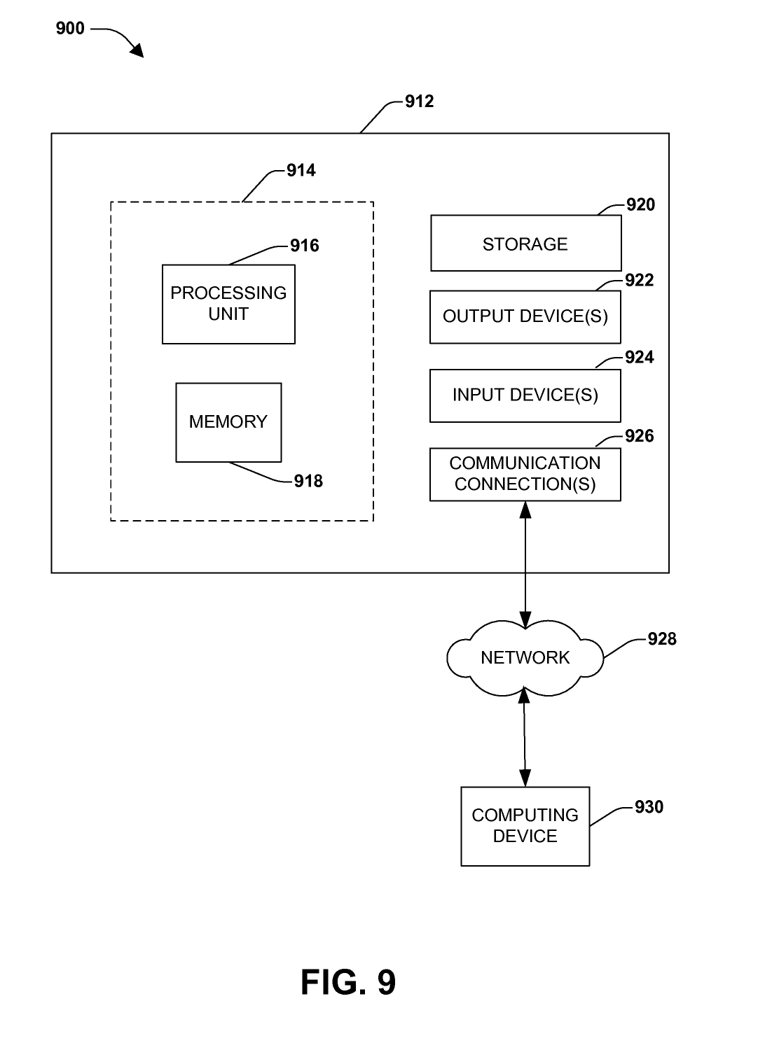

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 900 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 13104), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via a network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application.

What is claimed is:

1. A method for dynamically maintaining a service profile, comprising:
identifying an application as a service provider application;
receiving a service definition from the service provider application, the service definition defining a service associated with the service provider application;
generating a service profile for the service based upon the service definition; and
exposing the service profile to at least one of a system component or a second application.

2. The method of claim 1, the identifying an application comprising:
receiving an application manifest specifying a service provider parameter; and
validating the service provider parameter.

3. The method of claim 1, the identifying an application comprising:
validating installation information associated with the application during at least one of installation of the application or onboarding the application.

4. The method of claim 1, the receiving a service definition comprising:
exposing an operating system application programming interface (API) to the service provider application; and
receiving the service definition through the operating system API.

5. The method of claim 1, the receiving a service definition comprising:
identifying a service definition file stored within an operating system folder by the service provider application, the service definition file comprising the service definition.

6. The method of claim 1, the generating a service profile comprising:
storing the service profile into a service profile database dynamically maintained by an operating system.

7. The method of claim 1, the system component comprising an operating system interface, and the method comprising:
obtaining service information from the service utilizing the service profile, the service information associated with a user account of the service; and
displaying the service information through the operating system interface.

8. The method of claim 1, comprising:
invoking the second application to obtain service information from the service utilizing the service profile for display through the second application, the service information associated with a user account with the service.

9. The method of claim 1, the service profile comprising service display information specifying how the system component or the second application is to present the service.

10. The method of claim 9, the service display information comprising at least one of a service ID, a service display name, or a service icon.

11. The method of claim 1, the service profile comprising a set of capabilities associated with the service.

12. The method of claim 11, the set of capabilities comprising at least one of a messaging capability, a social network profile access capability, a video call capability, a phone call capability, an email capability, a social network post capability, a calendar access capability, or an action invokeable through the service.

13. The method of claim 1, comprising:
receiving a service profile update from the service provider application; and
updating the service profile based upon the service profile update.

14. The method of claim 1, comprising:
receiving a service profile removal request; and
removing the service profile based upon the service profile removal request.

15. The method of claim 1, comprising:
receiving a second service definition from the service provider application, the second service definition defining a second service;
generating a second service profile for the second service based upon the second service definition; and
exposing the second service profile to at least one of the system component or the second application.

16. A system for dynamically maintaining a service profile, comprising:
a service aggregator configured to:
identify an application as a service provider application;
receive a service definition from the service provider application, the service definition defining a service associated with the service provider application;
generate a service profile for the service based upon the service definition; and
expose the service profile to at least one of a system component or a second application.

17. The system of claim 16, the service aggregator owned by an operating system.

18. The system of claim 16, the system component comprising an operating system interface, and the service aggregator configured to:
obtain service information from the service utilizing the service profile, the service information associated with a user account of the service; and
display the service information through the operating system interface.

19. The system of claim 16, the service profile comprising service display information and a set of capabilities associated with the service.

20. A computer readable medium comprising instructions which when executed at least in part via a processing unit perform a method for dynamically maintaining a service profile, comprising:
identifying an application as a service provider application;
receiving a service definition from the service provider application, the service definition defining a service associated with the service provider application;
generating a service profile, within a service profile database dynamically maintained by an operating system, for the service based upon the service definition; and
exposing, by the operating system, the service profile to at least one of a system component or a second application.
